(19) United States
(12) Patent Application Publication
(10) Pub. No.: US 2020/0090648 A1
(43) Pub. Date: Mar. 19, 2020

(54) MAINTAINING VOICE CONVERSATION CONTINUITY

(71) Applicant: International Business Machines Corporation, Armonk, NY (US)

(72) Inventors: ISAAC WAWERU WAMBUGU, MARKHAM (CA); ELIZABETH ONDULA, NAIROBI (KE); VIOLETTE OGEGA, NAIROBI (KE); TIMOTHY NYOTA, NAIROBI (KE); SHIKHAR KWATRA, MORRISVILLE, NC (US); KOMMINIST WELDEMARIAM, NAIROBI (KE)

(21) Appl. No.: 16/132,023

(22) Filed: Sep. 14, 2018

(51) Int. Cl. G10L 15/22; G10L 15/18; G10L 19/005

(52) U.S. Cl. CPC G10L 15/22; G10L 2015/223; G10L 19/005; G10L 15/1815

(57) ABSTRACT

An inventive system includes a first electronic device, such as a cellular phone, that implements a method of detecting a voice conversation via the first electronic device; detecting an interruption of continuity of the voice conversation; and adapting operation of the first electronic device to maintain the continuity of the voice conversation. For example, adapting operation of the first electronic device may include auto-completing the voice conversation during the interruption of continuity. As another example, adapting operation of the first electronic device may include generating a text summary of the voice conversation during the interruption of continuity by activating a speech-to-text function and then transmitting to a second electronic device an electronic signal encoding the text summary. The method may include detecting a level of importance of the voice conversation by identifying a topic of the voice conversation.

### BACKGROUND

The present invention relates to electronic communication, and more specifically, to communication via degraded networks or in distracting environments.

A voice conversation (or a meeting or a call) can be conducted via electronic devices (e.g., mobile phones) between two people (current speaker and current listener), or among a group of people (current speaker and current listeners). While the listener(s) can hear and understand the speaker, continuity of the voice conversation exists. However, voice conversation continuity can be interrupted or destroyed by various factors, so that a voice conversation may be one-sided for a certain period, without the speaker noticing that the current listeners are not following the voice conversation. Destruction of voice conversation continuity can happen, for example, when a current speaker touches an “on-hold” or “mute” button on the speaker's electronic device, or when the quality of a communication network degrades (e.g., congestion, temporary service disruption), or when the listener(s) are exposed to ambient noise that is not known to the speaker. The destruction of voice conversation continuity can be worse when the speaker and/or listener(s) are in motion (e.g., walking while listening or speaking). In such cases, a communication connection still exists but audio is not transmitted to the listeners or is not perceived by the listeners.

In one instance, a speaker is explaining, discussing or describing important information, data or topic to a listener or a group of listeners. Such information may be time sensitive, i.e. may be helpful for the listener(s) to make real-time decisions (e.g., reporting incidents, reporting transactions, consultancy, direction guidance, project updates). Such information may be context dependent, e.g., when a listener is waiting to board a flight and the information relates to airport amenities or checked baggage.

### SUMMARY

Principles of the invention provide techniques for maintaining voice conversation continuity. In one aspect, an exemplary method includes detecting a voice conversation via a first electronic device; detecting an interruption of continuity of the voice conversation; and adapting operation of the first electronic device to maintain the continuity of the voice conversation.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a tangible computer readable storage medium (or multiple such media) and implemented on a hardware processor, or (iii) a combination of (i) and (ii); any of (i)-(iii) implement the specific techniques set forth herein.

In view of the foregoing, techniques of the present invention can provide substantial beneficial technical effects. For example, one or more embodiments provide one or more of:

Enhanced conversation continuity in the presence of conversation destruction factors.

Automation of conversation destruction factors via analysis of behavior and movement patterns of the speaker in relation to conversation destruction.

Predicting conversation continuity destruction factors based on estimated conversation importance.

Automatically associating conversation destruction factors with conversation context and characteristics.

Automation of conversation continuity for hearing disadvantage persons.

Reduction of overhead costs associated with establishing and sustaining new connections.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a cloud computing environment according to an embodiment of the present invention;

FIG. 2 depicts abstraction model layers according to an embodiment of the present invention;

FIG. 3 depicts a voice conversation continuity system according to an exemplary embodiment;

FIG. 4 depicts a method implemented by the system of FIG. 3, according to an exemplary embodiment;

FIG. 5 depicts a further method implemented by the system of FIG. 3, according to an exemplary embodiment; and

FIG. 6 depicts a computer system that may be useful in implementing one or more aspects and/or elements of the invention, also representative of a cloud computing node according to an embodiment of the present invention.

### DETAILED DESCRIPTION

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

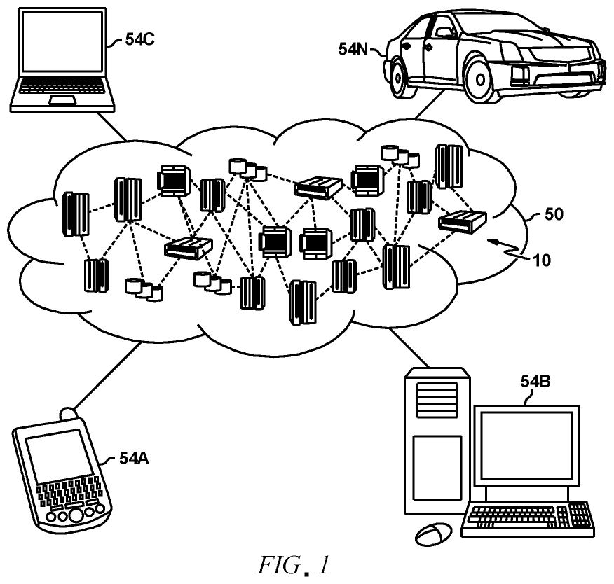

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

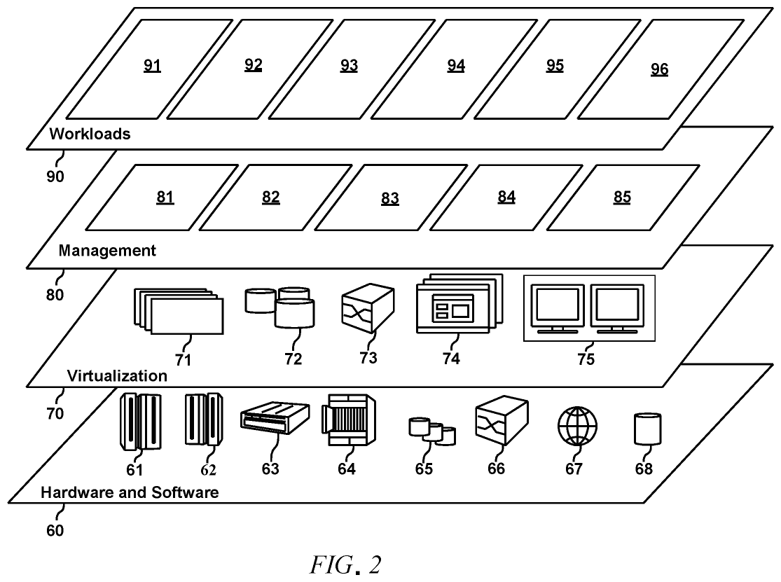

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and voice conversation continuity maintenance system 96.

One way to maintain the continuity of a voice conversation is by using a proximity sensor (available on some mobile phones/devices) that is activated to turn off the screen to prevent accidental on-hold button touching. However, this only prevents accidental touches if they happen from a certain angle and moreover the speaker needs to check that the sensor is on.

Another way to maintain the continuity of a voice conversation is to record the conversation by the listener for later use or replay. However, such an approach cannot work if the voice conversation is not audible to the listener in the first place.

Alternatively, the voice conversation can be stored in local storage of the speaker's device and later synchronized with remote/cloud storage so that it will be available for the listener to later replay it from the cloud. But this approach may have little utility if the voice conversation is important or time critical.

Accordingly, the system 96 implements a method that includes analyzing behavior and movement patterns of the speaker pertaining to triggering at least one conversation destruction factor and associating with the conversation context (e.g., project, client, personal, voice conversation center) and characteristics (e.g., stressful, intense) for the participants of the conversation. The method further includes establishing effective conversation continuity mechanisms for the phone voice conversation or conversation to continue while destruction factors remain present, by dynamically generating and/or selecting an effective strategy of conversation continuity such as deactivating “on-hold” or “mute” functionality of the speaker's device for a certain duration of time T, controlling a proximity sensor of the speaker's device, batch processing and streaming of the conversation to the listener or group of listeners as soon as continuity resumes (destruction factor no longer present), alerting the speaker to unmute, etc. The method further includes configuring and/or triggering a speaker's telecommunication means or devices automatically for the voice conversation or conversation continuity with a use of at least one effective strategy of the conversation continuity.

In other words, the system 96 intelligently facilitates a voice conversation to continue in the presence of conversation destruction based on analysis of conversation. For example, the system 96 analyzes a current context associated with a conversation between a speaker and one or more listeners, detects conversation continuity destruction factors between the speaker and the listeners, determines the importance of the conversation, generates conversation continuity strategies (e.g., deactivating the “mute” functionality of the speaker's device, batch streaming of the conversation to the listener with some delay), and based on the generated conversation continuity strategies, configures the speaker's device, listener's device and communication means to facilitate conversation continuity. In one embodiment, the importance of the conversation is determined by analyzing the conversation or voice data using a machine learning based voice analysis method (e.g., deep learning) that utilizes features extracted from the conversation or voice data, features received from the analysis of the current context, historical conversation or voice data, etc. to build a deep learning model for determining conversation importance (e.g., High, Low, Medium) in real-time.

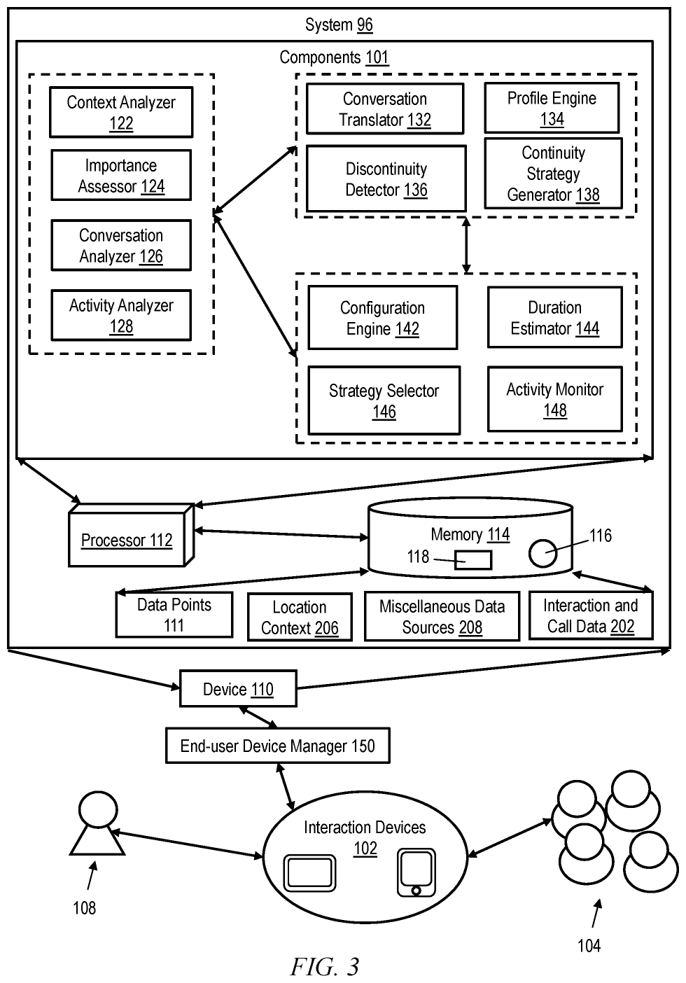

FIG. 3 depicts components 101 and general operation of the system 96. The system 96 interfaces with interaction devices 102, such as mobile phones, tablets and voice-enabled devices (e.g., Google Home and Amazon Echo). An end-user device manager 150 controls interactions of the devices 102 with the components 101 of the system 96, which are implemented by a device 110 that includes a processor 112 and/or data stores 114. The interaction devices 102 facilitate a voice conversation by connecting a speaker 108 with listeners 104. The device 110 implements an instance of the system 96 as further described below.

The device 110 receives data points 111, which include interaction and call data 202 (e.g., historical data of the user interaction with a device and historical call records of the user) and other miscellaneous data sources 208 (e.g., data from sensors, crowdsourcing, etc.). The memory 114 stores a conversation and metadata 116 and a database 118. An example of the conversation and metadata 116 includes a voice conversation of the speaker and metadata associated with the voice conversation (e.g., location, timestamp, speaker movement such as GPS data network characteristics, etc.) which later will be synchronized with remote or cloud storage. The processor 112 implements a context analyzer 122, an importance assessor 124, a conversation analyzer 126, and an activity analyzer 128.

The context analyzer 122 receives the data points 111 that relate to the context of the voice conversation, e.g., current, prior, and future calendar appointments, geo-locations of the speaker and the listeners, historical behavioral data, sensor data from the speaker's and listener's devices, the speaker and/or listener devices' characteristics, data from a user profile such as user preference, user has medical difficulty hearing, etc. Based on the contextual data points 111, the context analyzer 122 produces a context of the voice conversation and the speaker and/or listener context.

The conversation analyzer 126 determines the importance of a voice conversation through voice speaker/listener relationship understanding by employing custom design machine learning models or algorithms that may predict or estimate the “importance” of ongoing discussion or part of the conversation. For example, models of deep learning, convolutional neural networks, or recurrent neural networks can be built and trained using historical conversational data to determine the voice conversation importance. The importance level is further attributed by a temporal aspect of the conversation in relation to time sensitiveness that pertains to help a secondary entity involved in the conversation in making decision in topics such as reporting incidents, reporting transaction, consultancy, direction guidance, project updates, etc. In one or more embodiments, detecting the level of importance of the voice conversation further includes identifying the topics of the voice conversation using natural language processing. In one or more embodiments, determining the importance of a conversation further includes triangulating the temporal aspect of the conversation with contextual factors such as geo-location analysis.

For example, the method of speaker/listener relation understanding, as implemented by the context analyzer 122, may use regression models to understand the relationship of the speaker and listener or a group of second entities (conversation receivers) engaged in the voice conversation. In one or more embodiments, such models may be varied via input features inclusive of tone, language, time, content and the listener number/name (if stored in the speaker's mobile device). Principal component analysis for dimensionality reduction may be applied in order to simplify the model and use the various sources of detection and compute the relationship of the users via graphical analysis.

Along with speaker identification via variant of Gaussian or multivariate Student-t mixture models, other input parameters include contextual situation, agenda of discussion, meetings, level of engagement with the user (in order to define the relationship of the users engaged in the conversation as predicted from above mentioned regression model). The input parameters are fed to a multi-level neural networks learning algorithm in order to classify the level of importance of the conversation in multiple levels of thresholds which can be user configurable or dynamically learned by historical analysis of previous conversations and contextual situation.

In some embodiments, the conversation analyzer 126 may detect a topic of interest from the speaker explanation, response/reply by the listener, description of a project or important information, etc. The method of detecting the topic of interest further includes identifying and analyzing temporal aspects of the conversation (in terms of time sensitiveness) pertaining to helping a listener or entities involved in the conversation in making decision(s) such as reporting incidents, reporting transactions, consultancy, direction guidance, project updates, etc. The method still further includes triangulating the temporal aspect of the conversation with contextual factors such as location.

Using the context of the voice conversation, and analysis of the voice conversation by the conversation analyzer 126, the importance assessor 124 assigns a relative importance to the voice conversation, e.g. 5—Very High, 4—High, 3—Moderate, 2—Low, 1—Very Low.

Thus, the importance assessor 124 predicts importance of the voice conversation based on the content, identities of speaker and listener, identification of the focus of the conversation, correlation of the identified focus with historical conversation data, contextual situation and semantic analysis of the voice conversation i.e., the information retrieved from the regression model implemented by the conversation analyzer 122. In one or more embodiments, the importance assessor 124 takes into account multiple input features including content analysis which is detected via speech analysis by Mel Frequency cepstral coefficients (MFCC). If the information retrieved from the regression models is insufficient to feed to the classification model and determine the importance, then MFCC feature extraction and feature matching is used for mapping the extracted speech features with the users identified on the other side of the voice conversation and the historical analysis chart computes if a conversation has occurred with the relative party. If the user has had a conversation with the other user identified via MFCC speaker identification model, then the information is complete and can be fed to the classification model for importance classification.

The activity analyzer 128 extracts, aggregates and stores data on the user's activities. The method for identifying a user's current activity includes identifying and analyzing the user's location vis-à-vis activities going on in the user's vicinity. This method further aggregates data obtained from a user's device such as wearables, smartwatch, and mobile phone and uses the aggregated data to determine a user's activity.

Additionally, the device 110 implements a conversation translator 132, a profile engine 134, a discontinuity detector 136, and a continuity strategy generator 138 using the processor 112.

The conversation translator 132 performs a speech-to-text or vis-versa translation when a discontinuity is detected or predicted.

The profile engine 134 characterizes a user profile based on detected user activities, historical activities, etc., for example, the speaker is known to frequently touch the “on-hold” or “mute” button on his/her phone while speaking, the speaker mobility pattern while speaking, etc. The profile engine 134 further characterizes the communication network profile, e.g., profiling the quality (e.g., congestion, temporary service disruption) of the communication network, profiling surrounding or nearby ambient noise, etc. based on data received from a plurality of sources. Thus, the profile engine 134 infers the quality (e.g., congestion, temporary service disruption) of the communication network at a location L, profiles surrounding or nearby ambient noise at the location L, etc.

The discontinuity detector 136 detects whether some of the utterances are being blocked on either side. Using geo-spatial metrics, the discontinuity detector 136 also detects if a signal is being lost and/or a channel of communication is experiencing delays or transmission loss due to non-supportive locations and noisy zones. Using speech feature detection via MFCC algorithm, the discontinuity detector 136 also detects stammering, stuttering, lack of communication on either end, congestion in the network and muting/unmuting at inappropriate times.

The continuity strategy generator 138 produces one or more conversation continuity strategies or templates to continue the conversation between the speaker and listener(s). The one or more strategies may include completing missing pieces of conversation at the listener's device, controlling one or more functionality of the speaker's and/or listener(s)' devices, sending notification or suggestion, and so on. In one embodiment, the generated strategies or templates can be stored on both speaker and listener devices, or stored on remote database (e.g., Cloud) and pulled when a conversation between two users kicks off Alternatively, user supplied rules or specifications can be used to control the strategies or templates on the user device using the configuration engine 142. Once a classification model has been trained and is able to compute the importance of a conversation, real time detection is done as the outcome of the model when merged with geo-spatial metrics and speech feature detection as explained above.

In some embodiments, when a conversation discontinuity is detected or predicted, the discontinuity detector 136 triggers a strategy selector 146 to determine one or more suitable strategies or templates based on the analysis of the detected discontinuity. The continuity strategy generator 138 then instantiates the strategies on the speaker side, on the listeners' side or on both sides. The one or more strategies may include completing missing pieces of conversation for the listener(s) at the listener's device by conversation analyzer based on prediction, recalling or dialing immediately on behalf of the listener(s) when an obstruction is detected, notifying the speaker or listener(s) that some information is missing, notifying a listener who is in unfavorable location to change the location or respective zone in order to continue uninterruptible or less interruptible conversation, buffering some pieces of the conversation and storing on local or cloud database and so on. The strategy selector 146 is further responsible for producing at least one effective strategy for continuity of conversation based on the generated conversation continuity strategies. The selected strategy will be informed by context of conversation, learned patterns and strategies and input from other modules. In yet another embodiment, the strategy selector 146 may optimize the selected strategies using the outputs of the conversation translator 132 and profile engine 134.

Thus, once a discontinuity or conversation destruction has been detected in real time using one or more machine learning models, the processor 118 then implements multiple ameliorative actions (e.g., batch streaming of the conversation to the listener with some delay) based on the output of classification and learning models. For example, in one or more embodiments the continuity strategy generator 138 generates conversation continuity strategies by using cognitive neural networks to implement custom trained machine learning models based on the degree of importance of the phone call or conversation, predicted conversation continuity destruction factors, and analysis of the conversation continuity data.

Generally, a cognitive neural network includes a plurality of computer processors that are configured to work together to implement one or more machine learning algorithms. The implementation may be synchronous or asynchronous. In a neural network, the processors simulate thousands or millions of neurons, which are connected by axons and synapses. Each connection is enforcing, inhibitory, or neutral in its effect on the activation state of connected neural units. Each individual neural unit has a summation function which combines the values of all its inputs together. In some implementations, there is a threshold function or limiting function on at least some connections and/or on at least some neural units, such that the signal must surpass the limit before propagating to other neurons. A cognitive neural network can implement supervised, unsupervised, or semi-supervised machine learning.

In one or more embodiments, missing pieces of conversation are detected via a combination of the conversation analyzer 126, the discontinuity detector 136, and the duration estimator 144. Once the discontinuity detector 136 alerts to conversation destruction, the duration estimator 144 computes estimated duration of how long the conversation has been disconnected from the listener(s). The conversation analyzer 126 then uses the computed estimated duration to determine how long to go back into recorded/streamed conversation/audio data, and extracts the missing pieces of conversation by cross-referencing with the last piece of conversation that was transmitted to the receiver(s) device. If the importance level of the missed pieces of conversation is below a certain risk threshold, the discontinuity detector 136 does not trigger the strategy selection process (i.e., the strategy selector 146). The value of the risk threshold is determined experimentally or can be set by the user as constant value. The method of detecting missing pieces of conversation may further employ greedy or machine learning predictive models based on historical analysis of the conversation and other parameters (mentioned above) taken into the regression model and fed to the classification model. Hence, multiple ameliorative actions as an output of the final output model include:

Complete missing pieces by conversation analyzer based on prediction and historical conversation analysis.

Recall or dial immediately on behalf of the listener(s) when an obstruction is detected, notifying the speaker or listener(s) that some information is missing.

Unmute automatically based on determination of discontinuity factor and prediction.

Place call on hold and notify both current speaker and current listener(s) that the call has been discontinued, re-dialing immediately if an obstruction was detected.

Notify the users on either end that some information is missing.

Notify the user who is in unfavorable location to change the location or respective zone to continue with the seamless conversation.

Buffer some pieces of the conversation and storing in the cloud database and other configurable options.

In one or more embodiments, the system 96 selects at least one effective strategy of the conversation continuity such as deactivating the “on-hold” or “mute” functionality of the first entity's device for a certain duration of time T, controlling the proximity sensor, batch processing and streaming of the conversation to the second entity or group of entities (with some delay), alerting the user to unmute, etc. The method of selecting at least one effective strategy uses temporal factor and contextual factor (e.g., detecting a secondary user is boarding a flight) to further determine specific strategy such as storing the conversation on the first entity device and transferring to the second entity device for replay (e.g., when the user is flying).

In one exemplary embodiment, conversation continuity is hindered by hardware traffic congestion. An example is during a graduation ceremony in an area for instance. There is network congestion due to the influx of calls being made at the same time. The event is retrieved by the context analyzer 122 from the speaker's calendar or from a public events calendar for the area. Generally, the context analyzer 122 continuously analyzes network congestion based on the hour of the day, expected events in the area based on calendar and notifications, social media feeds and global events, or stream of data received from sensors. All these can point to a potential delay in connections or extreme congestions. Using machine learning algorithms (e.g., support vector machine models), the context analyzer 122 learns these temporal or recurrent issues so that the system can save conversations in real time and transmit once the network traffic is at acceptable bandwidth. Alternatively, the continuity strategy generator 138 auto-completes most of the conversations that are happening.

Auto-completion or reconstruction of lost packets can be accomplished when audio and visual communications use “user datagram protocol” (UDP) for transmission of packets and therefore during congestion, these packets are lost leading to gaps in a conversation stream. This gap can be estimated by the duration estimator 144 and auto-filled by the continuity strategy generator 138 in real-time at the earliest detection of a lost packet to ensure a smooth stream of conversation. By monitoring frequently used word(s) streams that a speaker makes with the listener historically and in the recent conversations, real-time machine learning support vector machine models can help determine the correct words to be used while monitoring the previous conversation can determine the sentiment of the conversation, thereby enabling the continuity model to reconstruct the lost packages with a high probability of success. Monitoring conversations after the network congestion is over will help get feedback on success or failure of the model.

The configuration engine 142 is responsible for arranging the parts and elements of a conversation in a logical and retrievable format on user device. The engine uses recorded input to map out relative disposition of the various elements of the conversation by utilizing contextual knowledge, artificial intelligence processing and analysis of the conversation via conversation analyzer 126. In some embodiments, the configuration engine 142 further establishes a contiguous conversation block and relays this to the strategy selector 146 and the activity monitor 148 for further processing.

In one or more embodiments, the duration estimator 144 predicts a duration during which the conversation is discontinued without being noticed by one or more listener or listeners. In one exemplary embodiment, the duration estimator 144 suspends an on hold functionality of the speaker's device for a certain duration of time.

As noted above, the strategy selector 146 is responsible for selecting at least one effective strategy for continuity of conversation based on the generated conversation continuity strategies. The selected strategy will be informed by context of conversation, learned patterns and strategies and input from other modules.

The activity monitor 148 is responsible for analyzing behavior and movement patterns of the listener with regards to the triggering of a destruction factor. The activity monitor 148 further continually tracks all user actions and activities in the conversation leading up to a specific destruction factor. Among other things, the activity monitor 148 tracks the location context 206, which specifies the various contextual characteristics at a given location L of a speaker or listener.

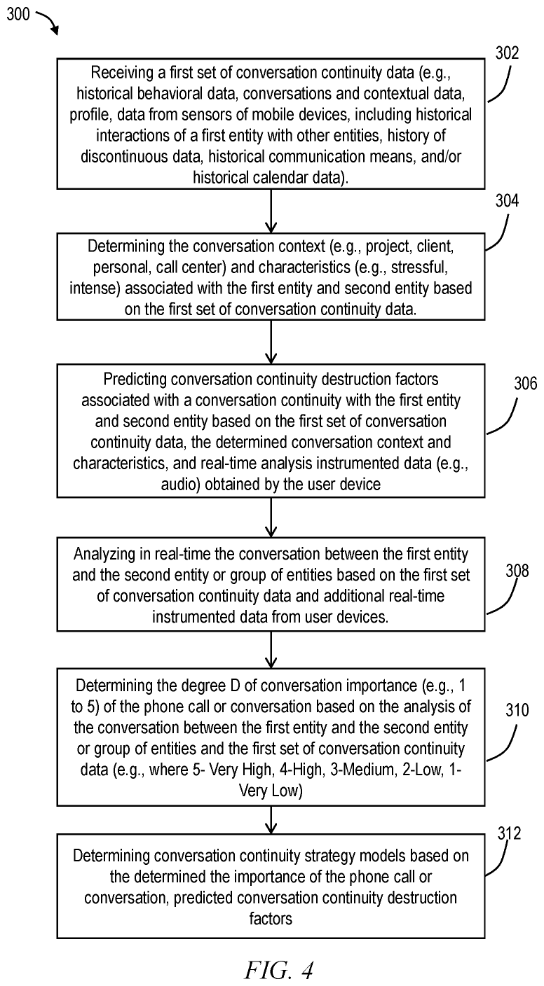

Thus, in one or more embodiments the system 96 implements a method 300 as shown in FIG. 4. The method 300 includes at 302 receiving a first set of conversation continuity data (e.g., historical behavioral data, conversations and contextual data, profile, data from sensors of mobile devices, including historical interactions of a speaker with listeners, history of discontinuities, historical communication means, and historical calendar data). At 304, determine a conversation context (e.g., project, client, personal, call center) and conversation characteristics (e.g., stressful, intense) that are associated with a speaker and a listener based on the first set of conversation continuity data. At 306, detect, determine or predict conversation continuity destruction factors associated with a conversation continuity between the speaker and the listener, based on the first set of conversation continuity data, the determined conversation context and characteristics, and real-time analysis of instrumented data (e.g., audio input) obtained by the speaker's device. At 308, analyze in real-time the conversation between the speaker and the listeners based on the first set of conversation continuity data and additional real-time sensed or instrumented data from user and/or computing devices such as mobile phone, tablets and voice-enabled devices (e.g., Google Home and Amazon Echo). At 310, determine a degree D of conversation importance (e.g., 1 to 5) of a voice conversation based on the analysis of the conversation between the speaker and the listeners and the first set of conversation continuity data. At 312, determine conversation continuity strategy models based on the determined importance of the voice conversation and predicted conversation continuity destruction factors. For example, if a detected or predicted destruction factor is signal degradation due to the speaker or listener being in a bad location, one exemplary conversation continuity strategy model is to record the voice conversation at the speaker's device and then replay the recording to the listener when the signal resumes clarity.

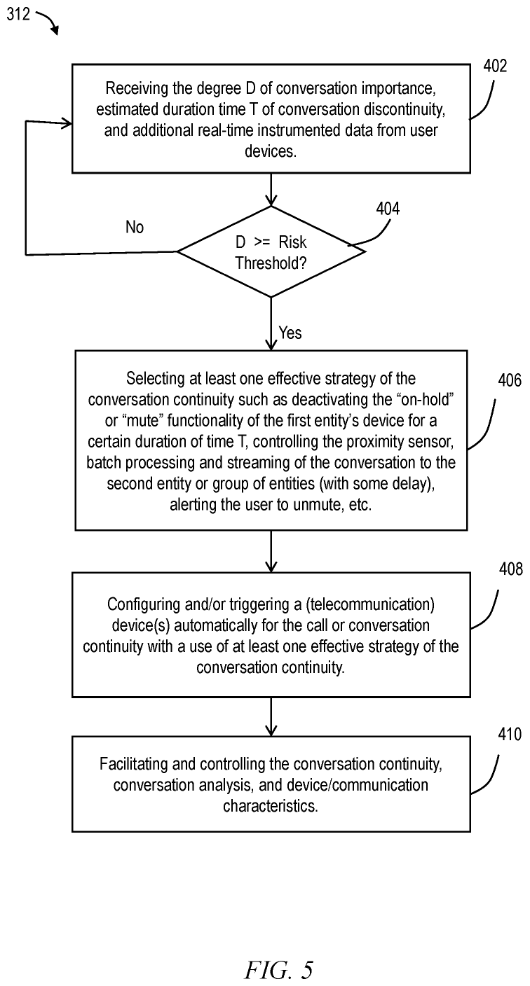

In one or more embodiments, step 312 of FIG. 4 includes several sub-steps as depicted in FIG. 5. At 402, receive the degree D of conversation importance, estimated duration time T of conversation discontinuity, and additional real-time sensed or instrumented data from user devices. At 404, compare the degree D to a risk threshold. As noted previously, the value of the risk threshold is determined experimentally or can be set by the user as a constant value. At 406, select by the continuity strategy generator 138 at least one effective strategy for conversation continuity such as, e.g., deactivating “on-hold” or “mute” functionality of the speaker's device for a certain duration of time, controlling a proximity sensor of the speaker's device, batch processing and streaming the voice conversation to the listener, alerting the speaker to unmute. At 408, configure and/or trigger the speaker's device automatically by the end-user device manager 150 for the voice conversation continuity with a use of at least one effective strategy for conversation continuity. At 410, facilitate and control the conversation continuity, conversation analysis, and speaker/listener device characteristics.

Given the discussion thus far, it will be appreciated that, in general terms, an exemplary method, according to an aspect of the invention, includes detecting a voice conversation via a first electronic device; detecting an interruption of continuity of the voice conversation; and adapting operation of the first electronic device to maintain the continuity of the voice conversation. In one or more embodiments, the exemplary method further includes detecting a level of importance of the voice conversation by identifying a topic of the voice conversation, using natural language processing. In one or more embodiments, the exemplary method adapts operation of the first electronic device only in case the level of importance of the voice conversation exceeds a threshold level.

In one or more embodiments, the voice conversation is between the first electronic device and a second electronic device, and detecting the interruption of continuity includes comparing, at the first electronic device, an electronic signal produced by the first electronic device to an electronic signal echoed by the second electronic device.

In one or more embodiments, the voice conversation is between the first electronic device and a second electronic device, and detecting the interruption of continuity includes comparing, at the second electronic device, audio produced by the second electronic device to audio detected by the second electronic device.

In one or more embodiments, adapting operation of the first electronic device includes, at the first electronic device, recording audio received by the first electronic device during the interruption of continuity and, by the first electronic device, after the interruption of continuity, transmitting to a second electronic device an electronic signal encoding the audio received during the interruption of continuity.

In one or more embodiments, adapting operation of the first electronic device includes, at the first electronic device, generating a text summary of the voice conversation during the interruption of continuity by activating a speech-to-text function, and then, by the first electronic device, transmitting to a second electronic device an electronic signal encoding the text summary. In one or more embodiments, the first electronic device transmits the electronic signal encoding the text summary during the interruption of continuity.

In one or more embodiments, adapting operation of the first electronic device includes, at the first electronic device, auto-completing continuity of an audio stream transmitted to the first electronic device from a second electronic device via a connection with dropped packets.

One or more embodiments advantageously improve the functioning of a computer and/or communications network and/or solve a problem unique to computers and/or communication networks. In particular, one or more embodiments of the invention resolve the problem of dropped signals (and/or other discontinuity factors) in cellular networks by, e.g., autocompleting a dropped conversation at the listener's end of the conversation.

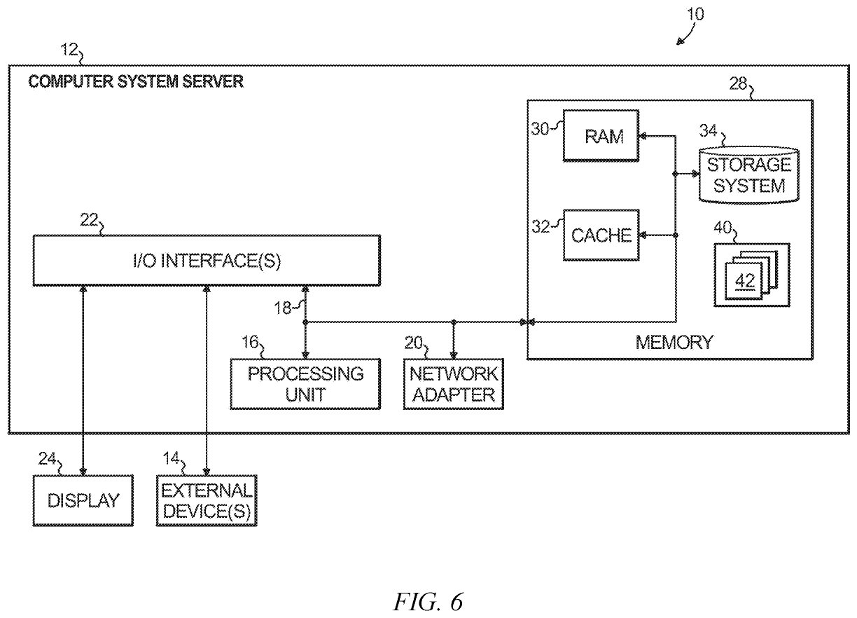

One or more embodiments of the invention, or elements thereof, can be implemented in the form of an apparatus including a memory and at least one processor that is coupled to the memory and operative to perform exemplary method steps, or in the form of a non-transitory computer readable medium embodying computer executable instructions which when executed by a computer cause the computer to perform exemplary method steps. FIG. 6 depicts a computer system that may be useful in implementing one or more aspects and/or elements of the invention, also representative of a cloud computing node according to an embodiment of the present invention. Referring now to FIG. 6, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 6, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 6) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 1-2 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

Exemplary System and Article of Manufacture Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
detecting a voice conversation via a first electronic device;
detecting an interruption of continuity of the voice conversation; and
adapting operation of the first electronic device to maintain the continuity of the voice conversation.

2. The method of claim 1 further comprising detecting a level of importance of the voice conversation by identifying a topic of the voice conversation, using natural language processing.

3. The method of claim 2 further comprising adapting operation of the first electronic device only in case the level of importance of the voice conversation exceeds a threshold level.

4. The method of claim 1 wherein the voice conversation is between the first electronic device and a second electronic device, and detecting the interruption of continuity includes comparing, at the first electronic device, an electronic signal produced by the first electronic device to an electronic signal echoed by the second electronic device.

5. The method of claim 1 wherein the voice conversation is between the first electronic device and a second electronic device, and detecting the interruption of continuity includes comparing, at the second electronic device, audio produced by the second electronic device to audio detected by the second electronic device.

6. The method of claim 1 wherein adapting operation of the first electronic device includes, at the first electronic device, recording audio received by the first electronic device during the interruption of continuity and, by the first electronic device, after the interruption of continuity, transmitting to a second electronic device an electronic signal encoding the audio received during the interruption of continuity.

7. The method of claim 1 wherein adapting operation of the first electronic device includes, at the first electronic device, generating a text summary of the voice conversation during the interruption of continuity by activating a speech-to-text function, and then, by the first electronic device, transmitting to a second electronic device an electronic signal encoding the text summary.

8. The method of claim 7 wherein the first electronic device transmits the electronic signal encoding the text summary during the interruption of continuity.

9. The method of claim 1 wherein adapting operation of the first electronic device includes, at the first electronic device, auto-completing continuity of an audio stream transmitted to the first electronic device from a second electronic device via a connection with dropped packets.

10. A non-transitory computer readable medium embodying computer executable instructions which when executed by a computer cause the computer to facilitate the method of:
detecting a voice conversation via a first electronic device;
detecting an interruption of continuity of the voice conversation; and
adapting operation of the first electronic device to maintain the continuity of the voice conversation.

11. The computer readable medium of claim 10, the method further comprising detecting a level of importance of the voice conversation by identifying a topic of the voice conversation, using natural language processing.

12. The computer readable medium of claim 11, the method further comprising adapting operation of the first electronic device only in case the level of importance of the voice conversation exceeds a threshold level.

13. The computer readable medium of claim 10 wherein the voice conversation is between the first electronic device and a second electronic device, and detecting the interruption of continuity includes comparing, at the first electronic device, an electronic signal produced by the first electronic device to an electronic signal echoed by the second electronic device.

14. The computer readable medium of claim 10 wherein the voice conversation is between the first electronic device and a second electronic device, and detecting the interruption of continuity includes comparing, at the second electronic device, audio produced by the second electronic device to audio detected by the second electronic device.

15. The computer readable medium of claim 10 wherein adapting operation of the first electronic device includes, at the first electronic device, recording audio received by the first electronic device during the interruption of continuity and, by the first electronic device, after the interruption of continuity, transmitting to a second electronic device an electronic signal encoding the audio received during the interruption of continuity.

16. The computer readable medium of claim 10 wherein adapting operation of the first electronic device includes, at the first electronic device, generating a text summary of the voice conversation during the interruption of continuity by activating a speech-to-text function, and then, by the first electronic device, transmitting to a second electronic device an electronic signal encoding the text summary.

17. The computer readable medium of claim 16 wherein the first electronic device transmits the electronic signal encoding the text summary during the interruption of continuity.

18. The computer readable medium of claim 10 wherein adapting operation of the first electronic device includes, at the first electronic device, auto-completing continuity of an audio stream transmitted to the first electronic device from a second electronic device via a connection with dropped packets.

19. An apparatus comprising:
a memory embodying computer executable instructions; and
at least one processor, coupled to the memory, and operative by the computer executable instructions to facilitate a method of:
detecting a voice conversation via a first electronic device;
detecting an interruption of continuity of the voice conversation; and
adapting operation of the first electronic device to maintain the continuity of the voice conversation.

20. The apparatus of claim 19 wherein adapting operation of the first electronic device includes, at the first electronic device, auto-completing continuity of an audio stream transmitted to the first electronic device from a second electronic device via a connection with dropped packets.
